(19) United States
(12) Patent Application Publication
(10) Pub. No.: US 2012/0055486 A1
(43) Pub. Date: Mar. 8, 2012

(54) Singing and speech propriosception device

(76) Inventor: Tobias Nobigrot, Miami, FL (US)

(21) Appl. No.: 12/927,680

(22) Filed: Nov. 22, 2010

Related U.S. Application Data
(60) Provisional application No. 61/398,416, filed on Jun. 25, 2010.

(51) Int. Cl. A61H 1/00

(52) U.S. Cl. 128/845

(57) ABSTRACT

An elastic, stretchable, flexible compression orthotic arranged as circumferential band's and with embedded solid objects on it's internal and external surfaces to provide general and discrete increased tactile compression load over the wearer's body part with which it is in contact, and formation of visual images as a mean of increasing and improving the wearer's body awareness and motor control over the body parts participating in production of speech or song as a mean of increasing voice production efficiency.

### CROSS-REFERENCE TO RELATED APPLICATION

This application claims the benefit of U.S. Provisional Patent Application Ser No. 61/398,416, filed Jun. 25, 2010, by present inventor. The entirety of which is hereby incorporated in this reference.

### STATEMENT REGARDING FEDERALLY SPONSORED RESEARCH OR DEVELOPMENT

“Not Applicable”

### BACKGROUND OF THE INVENTION

The present invention relates in general to an orthotic device, and in particular to a flexible compression orthotic device with visual landmarks, that provides sensory proprioceptive, and visual input which is useful in improving body awareness and motor control of the body parts participating in production of speech and song.

Currently (to our knowledge) there is no girdle system or orthotic device with visual landmarks, created specifically to provides sensory proprioceptive, and visual input which is useful in improving body awareness and motor control of the body parts participating in production of speech and song.

The human voice instrument differs from other musical instruments in that part of the singing or speech instrument in the human body is hidden from our view, so that learning to sing or speak efficiently requires the ability to visualize and feel simultaneously the body parts involved in the act of speaking or singing so that these parts can work in a synchronous way during the act of speaking or singing.

Learning to sing or speak efficiently requires focusing or placing the sound of the voice on the upper (cephalic) areas of the skull and face. This action which is called “voice placement” by traditional singing instructors, requires focusing ones attention on the upper or cephalic section of the forehead and occipital bone areas. This directed attention to the hard and non-contractable face and skull, decreases attention toward the muscles of the neck, oral, pharyngeal and laryngeal muscles, aiding in their relaxation, which, if accompanied by an uninterrupted and regulated supply of air to the adducted (closed) vocal folds (vocal chords), which is achieved by regulating (increasing or decreasing) the tone of the lower thoracic muscles, produces efficient speech or song.

Prior art has used orthotic devices as means for providing sensory input and body awareness to persons suffering from neurologic disorders like autism, proprioceptive and sensory deficits.

Prior Art Referenced for this section is as follows;

| Patent No; | Filling Date; | Inventor(s); |
|---|---|---|
| 5,412,957 | May 1995 | Bradberry et al. |
| 5,413,553 | May 1995 | Downers |
| 5,425,702 | June 1995 | Carn et al. |
| 5,449,341 | September 1995 | Harris |
| 5,498,234 | March 1996 | Martel et al |
| 5,582,583 | December 1996 | Ballantyne |
| 5,694,645 | December 1997 | Triplette |
| 5,708,978 | January 1998 | Johnsrud |
| 5,754,982 | May 1998 | Gainer |
| 5,782,790 | July 1998 | Allen |
| 5,957,873 | September 1999 | Allen |

### BRIEF SUMMARY OF THE INVENTION

The present invention relates to a method for providing sensory proprioceptive, and visual input which is useful in improving body awareness and motor control of the body parts participating in production of speech and song, to increase the efficiency of this activity. The flexible compression orthotic provides sensory input through a compression load to the portion of the body covered by the orthotic while the visual landmarks of the orthotic provide a visual image and increased awareness of some of the body parts receiving a compression load.

In a preferred embodiment, the material is elastic bands (like the one in underwear), regular clothing buttons and “Velcro” to adjust the length and circumference of it's different parts. In a preferred embodiment, the size of the orthotic is 70 to about 80% of the size of the body part covered by the orthotic so that the compression load be provided by the close fitting to a body part of the wearer, increasing and improving body awareness and motor control of the body parts participating in production of speech and song so that the efficiency of this activity can improve.

The Singing and Speech Proprioception Device consists of visual and proprioceptive landmarks which make it possible for the student or individual attempting to improve the efficiency of speech or song, to visualize and feel simultaneously the parts of the body involved in the act of talking or singing, so that these parts can participate concomitantly in voice production.

### BRIEF DESCRIPTION OF SEVERAL VIEWS OF THE DRAWINGS

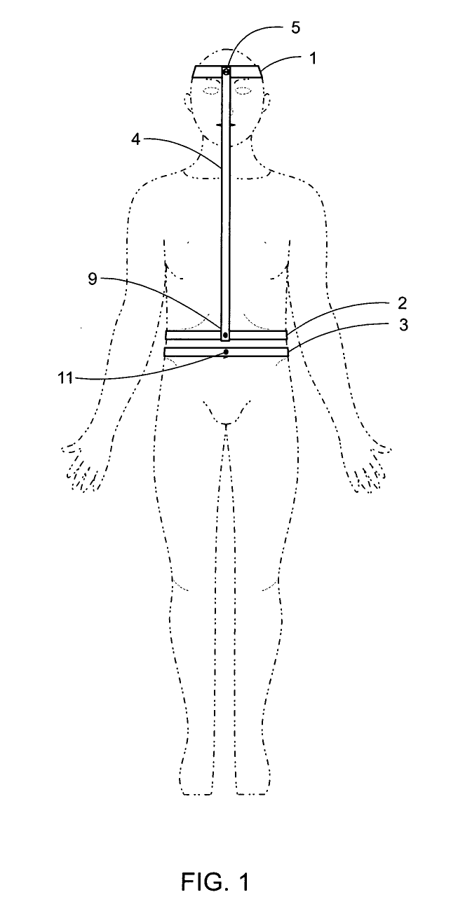

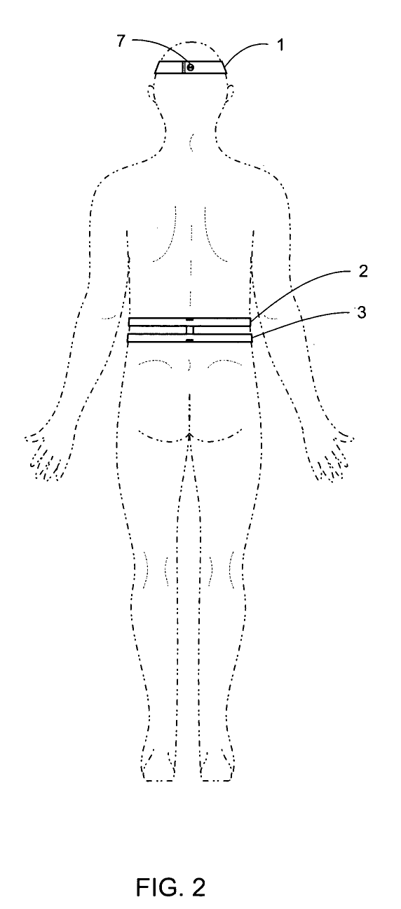

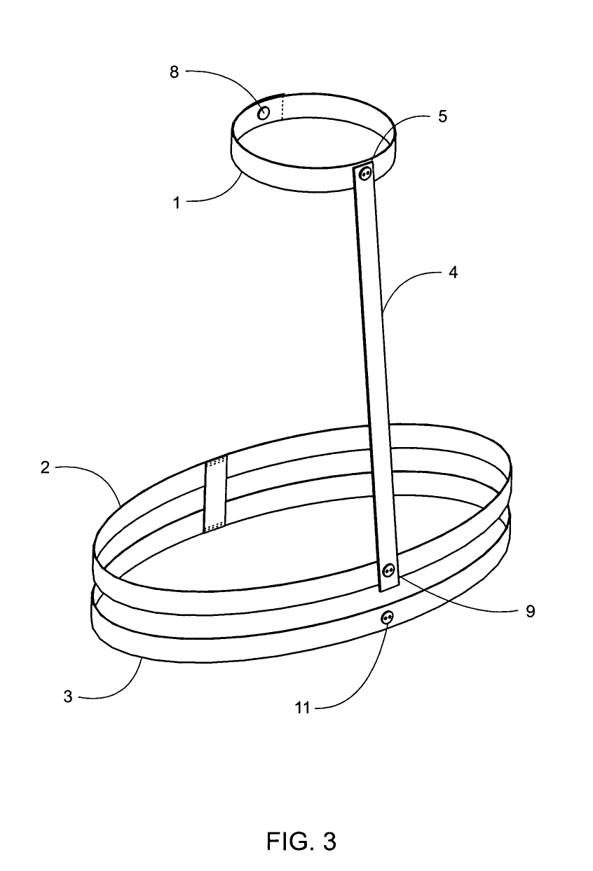

The preferred embodiment of the “Singing and Speech Proprioception Device”, FIG. 1, FIG. 2, FIG. 3 consists of three parts:

### The Head Band, FIG. 1.1

### The Trunk Bands, FIG. 1.2 and FIG. 1.3 and

The Connecting Band, FIG. 1.4, which connects the Head Band (FIG. 1.1) to the Trunk Bands (FIG. 1.2 and FIG. 1.3).

FIG. 1, Depicts a full frontal view of the apparatus, featuring a frontal views of the Head Band, FIG. 1.1; the Ventral External Button of the Head Band, FIG. 1.5; the Superior Trunk Band, FIG. 1.2; the Inferior Trunk Band, FIG. 1.3; the Ventral External Button of the Superior Trunk Band, FIG. 1.9; and the Ventral External Button of the of the Inferior Trunk Band, FIG. 1.11.

FIG. 2, Depicts a full dorsal view of the apparatus, featuring a dorsal view of the Head Band, FIG. 2.1; the Dorsal External Button of the Head Band, FIG. 2.7; the Superior Trunk Band, FIG. 2.2; and the Inferior Trunk Band, FIG. 2.3.

FIG. 3, Depicts an anterior oblique view of the apparatus form above, featuring an anterior oblique view from above of the Head Band, FIG. 3.1; the Superior Trunk Band, FIG. 3.2; the Inferior Trunk Band, FIG. 3.3; the Connection Band, FIG. 3.4; the Ventral External Button of the Head Band, FIG. 3.5; the Dorsal Internal Button of the Head Band, FIG. 3.8; the Ventral External Button of the superior Trunk Band, FIG. 3.9; and the ventral External Button of the Inferior Trunk Band, FIG. 3.11.

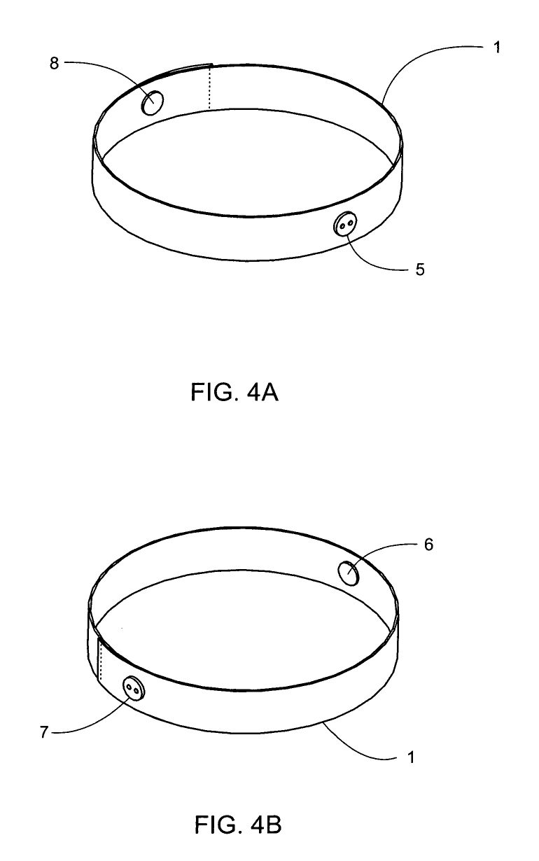

FIG. 4A, depicts an anterior oblique view from above of the Head Band, featuring an anterior oblique view from above of the Band (that forms the Head Band), FIG. 4A.1; the Ventral External Button of the Head Band, FIG. 4A.5; and the Dorsal Internal Button of the Head Band, FIG. 4A.8.

FIG. 4B, depicts a posterior oblique view from above of the Head Band, featuring the Band (that forms the head band), FIG. 4B.1; the Dorsal External Button of the Head Band, FIG. 4B.7 and the Ventral Internal Button of the Head Band, FIG. 4B.6.

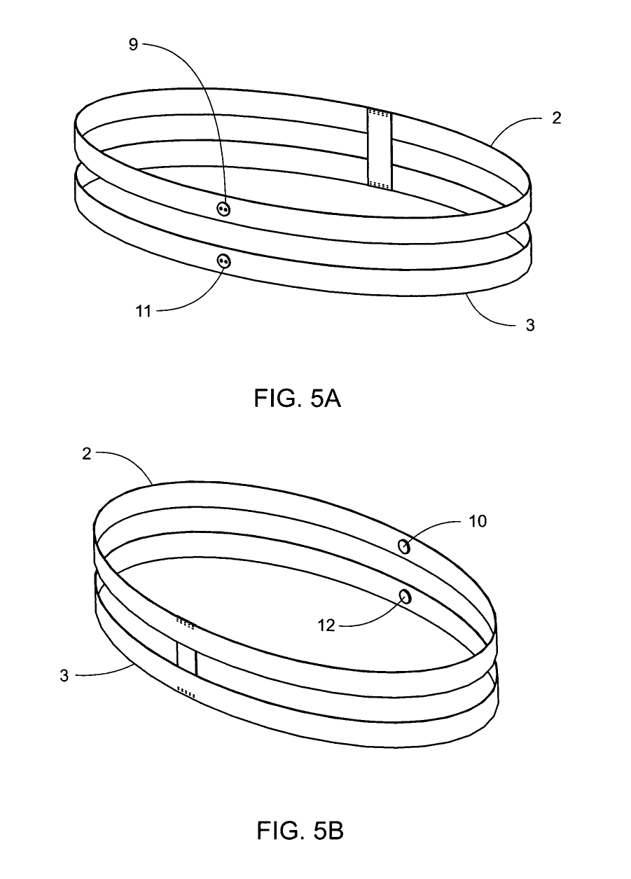

FIG. 5A, depicts an anterior view from above of the Trunk Bands, featuring an anterior oblique view from above of the Superior Trunk Band, FIG. 5A.2; the Inferior Trunk Band, FIG. 5A.3; the Ventral External Button of the Superior Trunk Band, FIG. 5A.9; and the Ventral External Button of the Inferior Trunk Band, FIG. 5A.11.

FIG. 5B, depicts a posterior oblique view from above of the Trunk Bands, featuring posterior oblique views from above of the Superior Trunk Band, FIG. 5B.2; the Inferior Trunk Band, FIG. 5B.3, the Ventral Internal Button of the Superior Trunk Band, FIG. 5B.10 and the Ventral Internal Button on the Inferior Trunk Band, FIG. 5B.12.

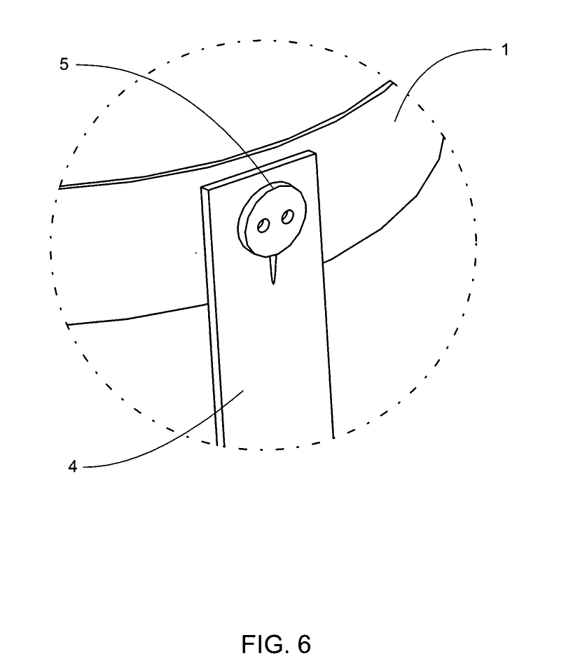

FIG. 6, depicts a close-up view of the mean of attachment of the Connecting Band, FIG. 6.4 to the Head Band, FIG. 6.1 (the same mean of attachment is used to connect the Connecting Band to the Superior Trunk Band, but it's not depicted)

### DETAILED DESCRIPTION OF THE PREFERRED EMBODIMENT OF THE INVENTION

The preferred embodiment of the “Singing and Speech Proprioception Device” consists of three parts; The Head Band, FIG. 1.1; The Trunk Bands, FIG. 1.2 and FIG. 1.3; and The Connecting Band, FIG. 1.4, which connects the Head Band (FIG. 1.1) to the Trunk Bands (FIG. 1.2 and FIG. 1.3).

These three parts (FIG. 1.1; FIG. 1.2 and FIG. 1.4), are interconnected (FIG. 1 and FIG. 6), and are made of elastic material and are smaller in size and length than the part of the user's body over which they are used, so that they can provide a compression load or tensile load to the portion of the body covered by the orthotic. It also includes hard objects embedded in various parts of the orthotic that come in contacts with the user's body to increase and accentuate the compression load on a particular area of the user's body over which the device is used. These hard embedded objects that serve to intensify the tactile compression load over a particular area of the user's body, also have a corresponding visual marker. The elastic bands together with the embedded hard objects and their corresponding visual markers, increase and improve body awareness and motor control of the body parts participating in production of speech or song and increase the ability of the user to visualize, feel and regulate simultaneously the various user's body parts involved in the act of talking or singing, so that these parts can participate concomitantly and synchronically in voice production, so that the efficiency of this activity can improve.

The Head Band, FIG. 1.1, FIG. 2.1, FIG. 3.1, FIG. 4A.1, FIG. 4B.1 and FIG. 6.1 is made of an elastic band lined at both ends by Velcro or any other means of adjustable linkage, and forms a circular shape that corresponds to the user's head circumference. The user wears this Head Band which surrounds the upper or superior forehead ventrally and the upper occipital scalp dorsally. The circumference of this head band is smaller than the circumference of the user's head so that the Head Band be able to provide a compression load over the user's head circumference. The Head Band has an embedded Ventral Internal Button, FIG. 4B.6 and a Dorsal Internal Button, FIG. 4A.8 and FIG. 3.8 which are in contact with the user's forehead and occipital scalp respectively and increase the tactile compression load and the subsequent user's body awareness of these body parts. These two Internal Buttons have corresponding external buttons,

FIG. 1.5, FIG. 3.5, FIG. 4A.5, FIG. 6.5 and FIG. 2.7, FIG. 4B.7 respectively, in the opposite (external) side of the elastic band which forms the Head Band, and are not in contact with the subject's skin or scalp. These external buttons or markers help the user create a visual image that corresponds to the areas on which the internal buttons exerted an increase tactile pressure load on discrete area of the wearer's forehead and occipital scalp.

Well trained singers and reputable singing instructors place special emphasis on “Voice Placement” and state that the voice should feel as if it is placed high on the face and skull and the Italian “Bell Canto” tradition calls for “Placing the voice in the Mask”

The Head Band, FIG. 1.1, FIG. 2.1, FIG. 3.1, FIG. 4A.1, FIG. 4B.1 and FIG. 6.1 with its elastic properties that are applied to the user's head circumference and the internal buttons, FIG. 4B.6 and FIG. 4A.8, as well as their corresponding external buttons, FIG. 4A.5 and FIG. 4B.7 allow the user to Visualize and Feel the areas of the face and skull on which the voice should be place or focused.

By concentrating his attention on these areas of the face and skull, the singer achieves severable desirable objectives like avoiding downward pressure on the larynx or tension on the tongue and peri-pharyngeal or laryngeal muscles and structures, and relaxation of the neck muscles as well as efficient use of the face and skull structures that are believed to participate in efficient voice resonance.

Well trained singers and reputable singing instructors place special emphasis on “voice support” and by this they mean in order to create the conditions for efficient voice production, the vocal chords have to have a constant, and regulated supply of air. To achieve this regular supply of air, the speaker or singer has to regulate intrathoracic pressure and avoid thoracic collapse by regulating the tone of the Lower Thoracic Muscles and indirectly the position of the Diaphragm.

The Superior and Inferior Thoracic Bands, FIG. 1.2, FIG. 1.3, FIG. 2.2, FIG. 2.3, FIG. 3.2, FIG. 3.3, FIG. 5A.2, FIG. 5A.3, FIG. 5B.2 and FIG. 5B.3 exert a circumferential compressive tactile load over the lower user's thorax and increases the user's awareness of this body section. The Internal Button of the Superior Trunk Band, FIG. 5B.10, exerts increased compressive tactile load over the area of the user's trunk that corresponds anatomically to the insertion of the Diaphragm, and the Internal Button of the Inferior Trunk Band, FIG. 5B.12, exerts increased compressive tactile load over the area that corresponds anatomically to the “Linea Alba” (“white line”) which is a connective tissue structure into which most of the midline lower trunk muscle insert. These two internal Trunk Band Buttons, have their corresponding External Buttons, FIG. 5A.9 and

FIG. 5A.11 which serve as visual markers for their corresponding Internal Buttons. The structures corresponding to FIG. 5A.2, FIG. 5A.3, FIG. 5B.10, FIG. 5B.12, FIG. 5A.9 and FIG. 5A.11 allow the user to better visualize and feel the trunk parts of the human body that help regulate the intra-thoracic pressure and as a consequence the air supply to the vocal chords by increasing body awareness and muscle tone control of this trunk areas involved in efficient speaking or singing.

The Connecting Band, FIG. 1.4, FIG. 3.4 and FIG. 6.4 connects the Head Band, (FIG. 1.1, FIG. 2.1, FIG. 3.1, FIG. 4A.1, FIG. 4B.1 and FIG. 6.1), to the Trunk Bands, (FIG. 1.1, FIG. 1.2, FIG. 2.2, FIG. 2.3, FIG. 3.2, FIG. 3.3, FIG. 5A.2, FIG. 5A.3, FIG. 5B.2 and FIG. 5B.3), through a button hole, FIG. 6, that attaches to the Ventral External Button, FIG. 6.5, of the Head Band superiorly and to Superior Ventral External Button, FIG. 3.9 of the Superior Trunk Band via one of three consecutive button holes, (not shown but identical to the one seen in FIG. 6

The elastic properties of the Connecting Band and its variable tensile properties, help the user increase it's awareness of the relative position and distance of the user's head relative to the trunk, helping to align the head and larynx with the air column which is supplied by the lungs within the thorax.

Learning to speak or sing efficiently is very much like learning to dance or learning to ride a bicycle, in that you cannot learn these skills by concentrating in isolation on each of the elements involved in the execution of the skill. Best results are achieved when we concentrate on all of the elements involved in learning the skill simultaneously.

The “Singing and Speech Proprioception Device” when worn by the user, exerts tactile pressure and compressive and elastic tension on the different parts of the human body involved in efficient speech or song, (Resonating Parts of the Head, and Supporting and Air Supply Parts of the Trunk). These elastic and compressive properties together with the embedded Visual Markers serve as a mean of increasing the user's awareness of the dimensions, shape, and relationship in space of the user's body parts that are in contact with the invention, increasing the user's control over the body parts that participate in efficient speaking or singing.

The internal buttons for this embodiment are simple buttons used for clothing, but vibrating elements are also suitable.

The external buttons for this embodiment are simple large clothing buttons in bright colors or with noticeable patterns so that they fulfill their function as visual markers, but pulsating light buttons or any other visually noticeable objects are also suitable.

I contemplate that elastic bands be used for the embodiment of these device but any other elastic material is also suitable.

I contemplate that Velcro be used to adjust the circumference of the Head Band and of the Trunk Bands, but other methods of length adjustment are suitable.

The width of the head band in a preferred embodiment is about 2.5 inches

The length of the head band in a preferred embodiment is about 23.5 inches

The Velcro overlap between both ends of the Head Band in a preferred embodiment is about 5 inches

The width of the link between the Trunk Bands in a preferred embodiment is about 2.5 inches

The length of the link between the Trunk Bands in a preferred embodiment is about 4.5 inches

The width of the Trunk Bands in a preferred embodiment is about 2.5 inches each

The length of the Trunk Bands in a preferred embodiment is about 37 inches each

The overlapping area on the linked Trunk Bands when attached by their ends in a preferred embodiment is about 6 inches in length

The width of the perpendicular bands that link the Superior and Inferior Trunk Bands in a preferred embodiment is about 2.5 inches

The length of the perpendicular bands that link the Superior and Inferior Trunk Bands in a preferred embodiment is about 4.6 inches

The distance between the 3 button holes that attach to the superior trunk band in a preferred embodiment is about 1.5 inches

The width of the Connecting band in the preferred embodiment is about 2.5 inches

The length of the Connecting band in the preferred embodiment is about 27 inches

The Diameter of the Hard Objects or Buttons attached or embedded on the internal and external surfaces of the elastic bands on the Head Band and the Trunk Bands in the preferred embodiment are about 2.5 inches each.

### GLOSSARY OF TERMS

Proprioception; awareness of the position and state (condition) of our own body parts

Cephalic; closest to the location of the head

“Voice Placement”; directing or feeling the vibrations of the voice to a discrete area of the body

Adducted; brought together

Ventral; closer to the location or position of the abdomen

Dorsal; closest to the location or position of the back

Internal; on the inside. In this particular case, the surface of the elastic band that is in contact with the wearer's skin, or the surface of said band that is not visible to a viewer when said band is being worn by the wearer

External; on the outside. In this particular case, the surface of the elastic band that is not in contact with the wearer's skin, or the surface of said band that is visible to a viewer when said band is being worn by the wearer

Superior; closest to the location of the head or cephalic

Inferior; closest to the location of the head or cephalic of the tail or caudal

1. An orthotic or girdle, formed of bands of elastic material united by their ends, to form a circumferential structure smaller in dimensions and diameter than the parts of the body over which said orthotic or girdle is worn, and with embedded or attached hard objects on the external and internal surfaces of said bands, for providing a compression load over human body parts over which said orthotic is worn, and for increasing body awareness on the user, to increase the efficiency of phonation, comprising;
a. a head band,
b. a trunk band, and
c. a connecting band which links the head band to the trunk band, or elastic means for linking the head band to the trunk band, whereby said orthotic or girdle provides general and discrete compression load on the human body part over which said orthotic or girdle is worn, to increase body awareness on the user of said orthotic or girdle and to increase the efficiency of phonation.

2. The orthotic of claim 1, wherein the portion of the body of the wearer, covered by the orthotic band know as the head band, is comprised of the soft tissues overlying the cephalic portion of the forehead bones, the parietal bones and the occipital bones, as a mean of subjecting said body parts to an increased compression load, and as a mean of directing the attention of the wearer and the voice placement of the wearer, to the resonating areas of the face and skull, as a mean of increasing voice production efficiency.

3. The orthotic of claim 2, wherein a hard object or button known as the ventral internal button of the head band, is attached to the internal surface of said elastic band or head band overlying the cephalic central forehead and in contact with the skin of said area, as a mean of increasing the discrete tactile pressure load over said part of the body in contact with said hard object or ventral internal button of the head band, as a mean of directing the attention of the wearer and the voice placement of the wearer, to a discrete area of the forehead in contact with said hard object or ventral internal button of the head band, as a mean of increasing voice production efficiency.

4. The orthotic of claim 3, wherein a hard object or dorsal internal button of the head band is attached to the internal surface of said elastic band or head band overlying the cephalic central area of the occipital scalp of the wearer, and in contact with it, as a mean of increasing the discrete tactile pressure load over said part of the body in contact with said hard object or dorsal internal button of the head band, as a mean of directing the attention of the wearer and voice placement, to a discrete area of the occipital scalp in contact with said hard object or dorsal internal button of the head band, as a mean of increasing voice production efficiency.

5. The orthotic of claim 4, wherein a hard objects or ventral external button of the head band, is attached to external surface of said orthotic band or head band, corresponding to the location of said hard object or ventral internal button attached to said internal surface of said head band, and overlying the forehead of the wearer, as a mean of creating a visual image of said discrete location on the wearer, and as a mean of directing the attention of the wearer and voice placement to said discrete area of the forehead over which the said solid object or ventral external button is placed, as a mean of increasing voice production efficiency.

6. The orthotic of claim 5, wherein a hard objects or dorsal external button of the head band, is attached to external surface of said orthotic band or head band overlying the occipital scalp of the wearer and corresponding to the location of said hard object or dorsal internal button located on said internal surface of said head band, as a mean of creating a visual image of said discrete location on the wearer, and as a mean of directing the attention of the wearer and voice placement, to said discrete area of the occipital scalp over which said hard object or dorsal external button is attached, as a mean of increasing voice production efficiency.

7. The orthotic of claim 1, wherein the portion of the body of the wearer covered by the orthotic band or superior trunk band, is comprised of the tissues overlying the portion of the thorax of the wearer, corresponding to the lower costal margin and the insertion of the diaphragm, as a men of subjecting said body part to an increased compression load and as a mean of increasing and improving body awareness and motor control of said body parts involved with voice support and air supply regulation to the vocal chords, as a mean of increasing voice production efficiency.

8. The orthotic band of claim 7, wherein a hard object or internal button of the superior trunk band, is attached to the internal surface of said band or superior trunk band, anteriorly bellow the xyphoid process of the rib cage of the wearer, as a mean of increasing and improving body awareness and motor control of said body parts involved with voice support and air supply regulation to the vocal chords, as a mean of increasing voice production efficiency.

9. The orthotic band of claim 8, wherein a hard object or external button of the superior trunk band is attached to the external surface of said orthotic band or superior trunk band, corresponding to the location of said solid object attached to the internal surface of said superior trunk band, or internal button of the superior trunk band, as a mean of creating a visual image of that discrete location on the wearer, and as a mean of increasing and improving body awareness and motor control of said body parts involved in voice support and air supply regulation to the vocal chords, as a mean of increasing voice production efficiency.

10. The orthotic of claim 1, wherein the portion of the body of the wearer covered by the orthotic band or inferior trunk band is comprised of the tissues overlying the portion of the thorax of the wearer corresponding to the lower trunk muscles, as a men of subjecting these body part to an increased compression load and as a mean of increasing and improving body awareness and motor control of said body parts involved with voice support and air supply regulation to the vocal chords, as a mean of increasing voice production efficiency.

11. The orthotic of claim 10, wherein a hard object or internal button of the inferior trunk band, is attached to the inner surface of said band or inferior trunk band, anteriorly, and in contact with the tissues overlying the Linea Alba of the wearer, into which most of the midline lower trunk muscle insert, as a mean of increasing and improving body awareness and motor control of said body parts involved with voice support and air supply regulation to the vocal chords, as a mean of increasing voice production efficiency.

12. The orthotic of claim 11, wherein a hard object or external button of the inferior trunk band, is attached to the external surface of said orthotic band or inferior trunk band, corresponding to the location of said hard object or internal button of the inferior trunk band, located on said internal surface of the inferior trunk band, as a mean of creating a visual image of said discrete location on the wearer, and as a mean of increasing and improving body awareness and motor control of said body parts involved with voice support and air supply regulation to the vocal chords, as a mean of increasing voice production efficiency.

13. The orthotic of claim 12, wherein an elastic band or connecting band is attached ventrally by one end, to said orthotic band or head band overlying the head of the wearer, and by the other end, to said orthotic band or superior trunk band overlying the inferior costal margin of the wearer, as a mean of increasing awareness on the wearer of the connection and distance between said orthotic band or head band overlying the head of the wearer and said orthotic band of superior trunk band overlying the inferior costal margin of the wearer, as a mean of improving body awareness and motor control between the resonating areas of the face and skull and the body parts involved with voice support and air supply regulation to the vocal chords, as a mean of increasing voice production efficiency.
